(19) United States
(12) Patent Application Publication
(10) Pub. No.: US 2008/0240804 A1
(43) Pub. Date: Oct. 2, 2008

(54) SELF ACTUATED INTERMITENT FUSER SKIVE

(76) Inventor: David E. Bettiol, Rush, NY (US)

Correspondence Address: David A. Novais;Patent Legal Staff, Eastman Kodak Company, 343 State Street, Rochester, NY, 14650-2201, US

(21) Appl. No.: 11/692,265

(22) Filed: Mar. 28, 2007

(51) Int. Cl. G03G 15/20

(52) U.S. Cl. 399/323

(57) ABSTRACT

An apparatus to intermittently skive the paper and/or toner from a roller to prevent the paper and/or toner sticking to the roller and thus keep the paper moving along the transport path. The self-actuated skive intermittently touches the roller to minimize contact with the roller as the receiver moves along the transport path past the fuser by automatically optimizing the timing and force that the self-actuated skive touches the roller.

### FIELD OF THE INVENTION

The invention relates generally to the field of print finishing, and more particularly to a device and method for fixing toner onto a receiver, also referred to as a receiver, using an automated skive.

### BACKGROUND OF THE INVENTION

Many electrographic printers/copiers use rollers to feed material to a nip near a web. A pressure sensitive roller and a heated roller form a nip. During fusing, after printing, the pressure sensitive roller and heated roller are in pressure contact with one another in what is referred to as contact fusing. If heated rollers do contact the receiver it is referred to as contact fusing and if not they are referred to as non-contact fusing.

Although the non-contact fusers do reduce wear and maintenance in electrographic printers, many of the non-contact fusing systems have suffered from the absence of a contact roller for toner dot spreading, which acts as an assist for toner/receiver surface wetting and gloss modulation. This is due to the fact that the surface finish of the roller coating is normally used to act as a gloss modulator in contact fusing systems but is not available in the non-contact fusing systems currently available. Without the use of the roller, the non-contact fuser can cause large differences in toner gloss (luster) from light scattering off of separate toner particles at low to mid range color densities that produce low gloss, and solid high density layers of toner that produce high gloss. Rollers tend to modulate the gloss to near the finish of the roller coating except when toner particles are separated enough to scatter light at low lay-downs (or low to mid range color densities), where the rollers tend to spread the toner dots to reduce the light scattering effect that produces low gloss. Non-contact systems toner formulations can also produce various limitations for non-contact fusing image quality. Many non-contact fusers operate in conjunction with a toner that has a sharp melting point and attains a low enough viscosity to attain a high gloss level at high toner lay-downs (highest color densities). These toner types tend to have other associated problems such as cratering which leads to poor quality results. Cratering can be attributed to volatiles escaping through a molten toner layer: gasses push their way through the molten toner layer leaving a toner void surrounded by a rim of toner that looks very similar to a volcanic crater, or a meteor crater. In some cases the non-wetting of the toner melt can lead to image artifacts such as lower gloss and image density in a manner similar to cratering.

There is a need for a printer that wears well and does not have associated maintenance problems but also works well with a contact fuser. The self-adjusting intermittent fuse skive is described below works in conjunction with the electrographic printer.

### SUMMARY OF THE INVENTION

In accordance with an object of the invention, an apparatus is provided for improving the quality of print finishes using a self-adjusting intermittent fuser skive, in conjunction with a fuser roller that minimally touches the roller to skive the paper and/or toner from the roller without wearing the roller surface.

The primary function of the self-actuated skive is to intermittently skive the paper and/or toner from a roller to prevent the paper and/or toner sticking to the roller and thus keep the paper moving along the transport path. The self-actuated skive intermittently touches the roller to minimize contact with the roller as the receiver moves along the transport path past the fuser by automatically optimizing the timing and force that the self-actuated skive touches the roller and prevent undesirable wear on the actuator tip and the roller surface and thus reduces print quality. The objective is to minimize any undesirable and unnecessary contact with the roller as the receiver moves along the transport path past the fuser by automatically optimizing the timing and force that the self-actuated skive touches the roller to minimize wear and maximize efficiency.

### BRIEF DESCRIPTION OF THE DRAWINGS

FIG. 1 shows an electrographic print engine.

FIGS. 2 and 3 show a skive system.

FIG. 4 shows a portion of a fuser.

FIG. 5 shows a preferred embodiment of the fuser with the skive system that shows when the paper actuates self-actuated skive so that the actuator tip is not in contact with the roller surface.

### DETAILED DESCRIPTION OF THE INVENTION

The present description will be directed in particular to elements forming part of, or cooperating more directly with, apparatus and methods in accordance with the present invention. It is to be understood that elements not specifically shown or described may take various forms well known to those skilled in the art.

In the apparatus and method of this invention more than one imaging member, as defined above, can be used. Typically, an apparatus for making single color final toner images has a single primary imaging member, and an apparatus for making multi-color final toner images has either one or more than one primary imaging members. In some embodiments of the invention, to make multi-color toner images, a single primary imaging member can be used to make each individual electrostatic image for each color separation and then the individual color toner images are transferred from the primary imaging member to the ITM sequentially and in registration. The method comprises forming one electrostatic image on a primary imaging member corresponding to one color in the desired toner image; toning by applying the corresponding color marking toner particles to the electrostatic image to form an individual color toner image; and transferring the individual color toner image to the surface of an ITM in the presence of an electric field which urges the individual toner image toward the ITM and repeating the forming, toning and transferring steps for each color separation in a desired toner image.

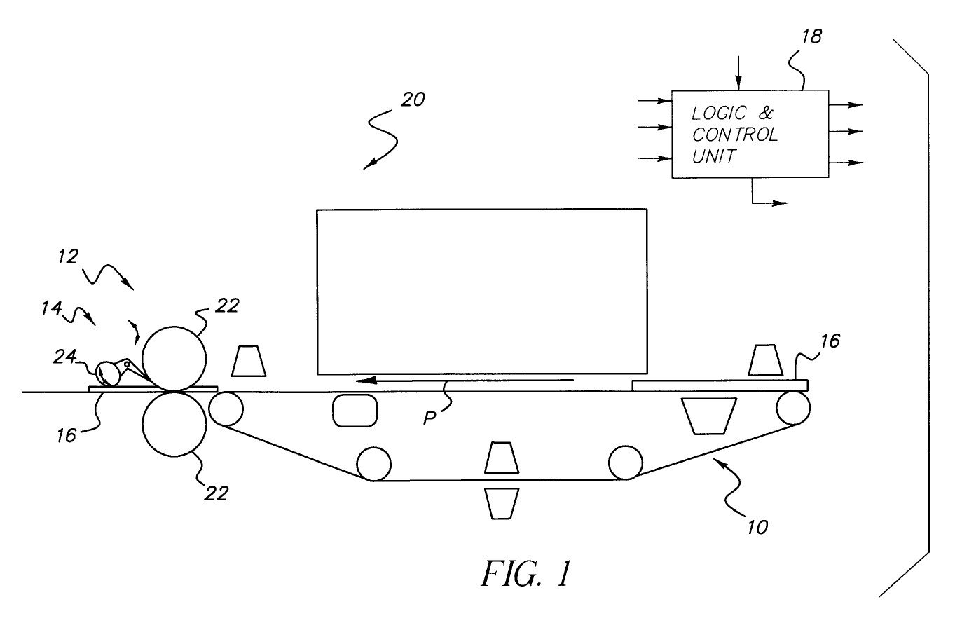

FIG. 1, shows generally, schematically, a portion of an electrographic apparatus 10 with a skive system 12 including one or more self-activated skives 14. The electrographic apparatus 10 is generally referred to as an electrographic printer that incorporates a printing system in accordance with the methods and systems described below. The electrographic printer 10 includes a moving electrographic imaging member such as a photoconductive drum(not shown), which is driven by a motor to advance the drum, which advances the receiver 16 in the direction indicated by arrow P. Alternatively the drum may be a belt that is wrapped around a drum or it may be a belt that is wrapped around one or more rollers. Note that the substrate or receiver 16 may be any medium to be imaged and or coated such as a substrate, receiver or web.

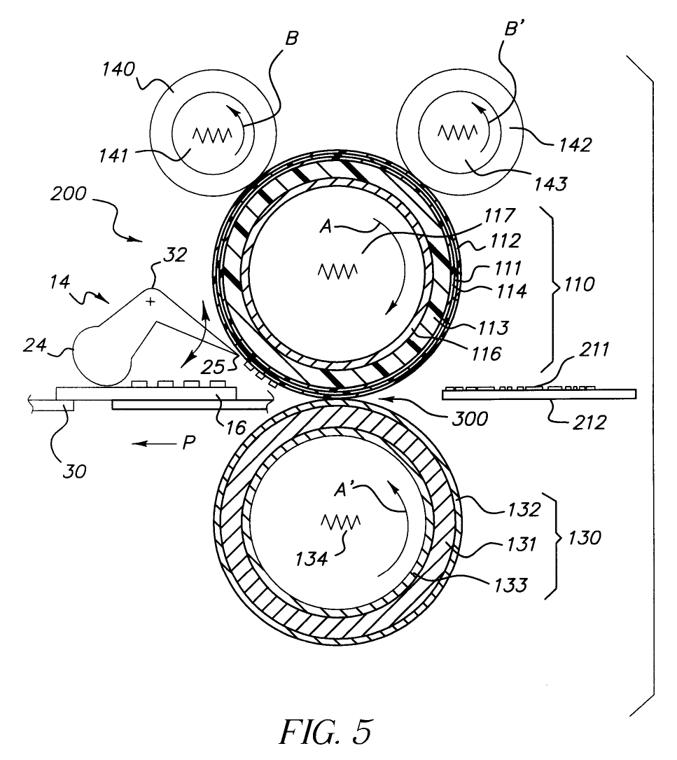

The electrographic apparatus 10 includes a controller or logic and control unit (LCU) 18 that is programmed to provide closed-loop control of printer 10 in response to signals from various sensors and encoders. Aspects of process control are described in U.S. Pat. No. 6,121,986 incorporated herein by this reference. In the electrographic apparatus 10, a toner development station is provided for storing a supply of toner particles and selectively depositing toner particles on a latent image charge photoconductive drum and onto the receiver as shown in FIG. 5. When the charge on the toner particles is at a proper level, the particles will develop the latent image charge patterns into a suitable visible image. Thereafter, the visible toner particles image is transferred to a receiver member 16, which is often referred to as a substrate or receiver, and is fixed to the receiver member by a fuser 20, to form the desired image. One skilled in the art understands that the receiver could be paper that is printed or non-printed or a non-paper, such as metal, ceramics, photoconductor, textile, glass, plastic sheet, metal sheet, paper sheet and other bases that are capable of receiving a toner or toner related material. It will be understood that an optional supplementary source of heat for fusing, either external or internal, may be provided, directly or indirectly, to any roller included in a fusing station of the invention.

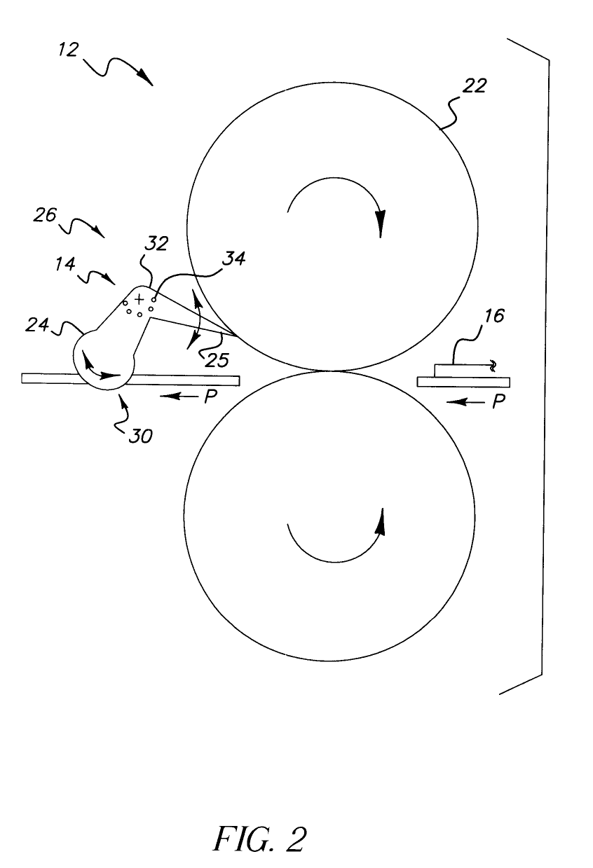

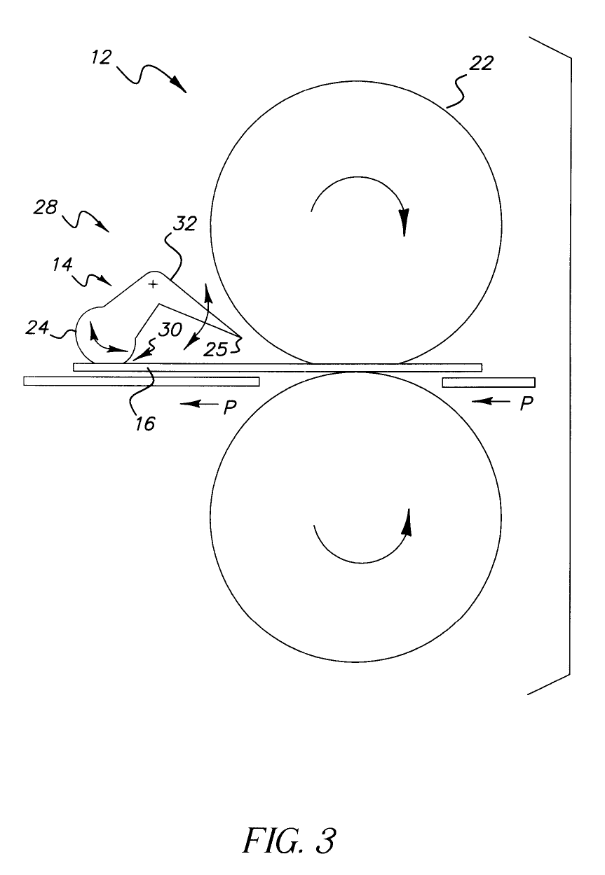

The self-activated skive system 12 shown in FIGS. 2 and 3 works in conjunction with the receiver 16 to keep the receiver and/or toner particles from sticking to the roller and moves it along the transport path. The skive system 12 includes one or more contact rollers 22 that can be in contact with the receiver 16 in a first travel path P and one or more self-actuating skives 14 located downstream the contact roller 22 to guide the receiver 16 away from the roller 22 in the first travel path P. The self-actuating skive 14 includes an actuation arm 24 and an actuation tip 25 such that the actuation arm 24 is in a first position 26 when the receiver 16 is not in contact with the arm at the first end or flag position 30. When the actuator arm is in second position 28, the actuator tip 25 is brought away from the roller such that the actuator arm in the second position that is proximate but is not in contact with the receiver thus preventing contact with the roller to minimize the time the actuator tip 25 is in contact with the roller. The proximate location is one that is very near the roller but generally not touching Since these distances are very small and subject to occasional touching but that contact is minimized due to the current invention. The self-actuated skive intermittently skives the paper and/or toner from a roller to prevent the paper and/or toner sticking to the roller and minimize contact with the roller as the receiver moves along the transport path past the fuser. The self-actuated skive automatically optimizes the timing and force that the self-actuated skive touches the roller.

The actuating arm is moved about pivot 32 when a receiver 16 contacts the actuating arm as the receiver moves along said travel path P. The self-actuating skive may further interact with the controller 18 in communication with the self-actuating skive 14 and the roller to control the pressure on the receiver 16 as it passes the rollers 22 based on information received from the self-actuating skive 14. The self-actuating skive should have a somewhat smooth finish on the portion of the self-actuating skive potentially in contact with the receiver, such as the first end, so that the receiver moves past the self-actuating skive without hindrance since it is important to keep traction on the receiver to a minimum. It is equally important for the actuator tip to have a smooth surface so that it does not mark/wear the roller surface during the time it is in contact with the roller. This minimized the undesirable side effect described above.

The self-actuating skive 14 also can include a spring device 34 to control the tension on the self-actuating skive to control and balance the force the actuator tip exerts on the roller when it is engaged with the roller 22 so that the self-actuating skive can be spring actuated. A spring enhanced self-actuated skive may be useful to help customize the force the skive has on the roller 22 and to balance this force with the force the acting on the receiver as it moves along the first travel path P past the self-actuated skive 14.

A controller, including a tension controller, can be control the tension on the self-actuating skive by controlling the force between self-actuated skive and the roller. A skive profile may be stored and/or created on self-actuated skive to work with the spring to controllably decrease and/or increase the force between the skive and the roller. The receiver, which has at least one property such as thickness, can interact with the controller logic and control system may adjust the predetermined amount of spring force according to that one or other properties. For example a thicker substrate will move the actuator tip farther from the roller surface and it will be more important for the system to get the actuator tip back in to the skiving (touching) position after the sheet leaves the actuator arm.

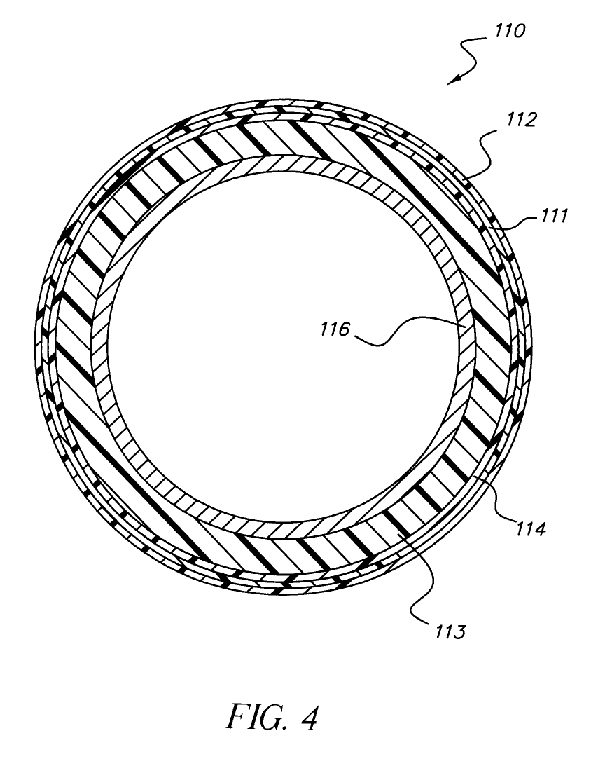

FIG. 4 shows a cross-sectional view of a fuser member 110, according to one embodiment of the invention, of which the applications include fuser rollers, pressure rollers, and oiled donor rollers, etc. The generally concentric central core or support 116 for supporting the plurality of the layers is usually metallic, such as stainless steel, steel, aluminum, etc. The primary requisite for the central core 116 materials are that it provides the necessary stiffness, being able to support the force placed upon it and to withstand a much higher temperature than the surface of the roller where there is an internal heating source. Deposited above the support 116 is a resilient layer, also termed the base cushion 113, which is characterized in the art as a “cushion” layer, with a function to accommodate the displacement for the fusing nip. Deposited above the base cushion layer 113 is a tie layer 114, which can be made of Viton, fluoroelastomer, or other fluoropolymer, such as fluorocarbon thermoplastic copolymer and mixtures thereof. Subsequently deposited above the tie layer 113 is a primer layer 111. The outermost layer 112, is a toner release layer, which comprises the fluoropolymer resins, including PTFE, PFA, and FEP, etc. and blends thereof, deposited on the primer layer 111.

Referring now to the accompanying drawings, FIG. 5 shows a 0ne embodiment of the fuser station with a self-actuated skive system 12, inclusive of the inventive fuser roller structure, as designated by the numeral 200. The rotating fuser roller 110 moving in the direction indicated by arrow A includes a plurality of layers disposed about the axis of rotation. The plurality of the layers including a cylindrical core member 116 of high stiffness material, such as aluminum or steel, a relatively thick compliant base-cushion layer (BCL) 113, formed or molded on the core with perfect bondage at the interface, a seamless and relatively thin Viton layer 114, coated on top of the BCL 113, a seamless and relatively thin primer layer 111 coated on the Viton layer 114, with perfect bondage at the interface and a seamless and relatively thin topcoat 112 of relatively stiffer material such as PFA than the elastomeric materials, coated on top of the primer layer 111, with perfect bondage at the interface. The PFA topcoat is a thermally resistant layer used for release of the receiver from the fusing member 110. This is enhanced by the use of the self-actuated skive system 12.

The surface of the fuser roller 110 can be externally heated by heater rollers, 140 and 142, which are of incandescent or ohm-rated heating filament 141 and 143, or internally heated by the incandescent or ohm-rated heating filament 117, or heated by the combination of both external heater rollers, 140 and 142, and internally heating incandescent or ohm-rated filament 117. A counteracting pressure roller 130 rotating in the direction A′, countering the fuser roller rotating direction A forms a fusing nip 300 with the fuser roller 110 made of a plurality of compliant layers. An image-receiving receiver 212, generally paper, carrying unfused toner 211, i.e., fine thermoplastic powder of pigments, facing the fuser roller 110 is shown approaching the fusing nip 300. The receiver is fed by employing well know mechanical transports (not shown) such as a set of rollers or a moving web for example. The fusing station is preferable driven by one roller, for instance the fusing roller, 110, with pressure roller 130 and optional heater rollers, 140 and 142, being driven rollers.

The fuser member can be a pressure or fuser plate, pressure or fuser roller, a fuser belt or any other member on which a release coating is desirable. The support for the fuser member can be a metal element with or without additional layers adhered to the metal element. The metal element can take the shape of a cylindrical core, plate or belt. The metal element can be made of, for example, aluminum, stainless steel or nickel. The surface of the metal element can be rough, but it is not necessary for the surface of the metal element to be rough to achieve good adhesion between the metal element and the layer attached to the metal element. The additional support layers adhered to the metal element are layers of materials useful for fuser members, such as, silicone rubbers, fluoroelastomers and primers.

The invention has been described in detail with particular reference to certain preferred embodiments thereof, but it will be understood that variations and modifications can be effected within the spirit and scope of the invention.

1. An apparatus for guiding a receiver along a travel path, comprising:
a. a roller in contact with the receiver in a travel path; and
b. one or more self-actuating skives located downstream the contact roller to guide the receiver away from the roller in the said travel path.

2. The apparatus of claim 1 further comprising an actuation arm that is in a first position when the receiver is not in contact with the arm and in a second position when the arm is in contact with the receiver.

3. The apparatus of claim 2 wherein the actuating arm is moved so the tip is proximate the roller when the receiver contacts the actuating arm as the receiver moves along said travel path.

4. The apparatus of claim 1 further comprising a controller in communication with the self-actuating skive and the roller to control the pressure on the receiver as it passes the rollers based on information received from the self-actuating skive.

5. The apparatus of claim 1 further comprising a smooth finish on the arm and the tip of the self-actuating skive.

6. The apparatus of claim 1 further comprising a tension controller to control the tension on the self-actuating skive by controlling the force between the skive and the roller.

7. The apparatus of claim 1 further comprising a spring actuated self-actuating skive.

8. A method of printing controlling the movement of a receiver along a first travel path guided by a self-actuated skive.

9. The method of claim 8 further comprising controlling the movement using a spring actuated arm.

10. The method of claim 8 further comprising a profile on the skive to controllably decreasing the force between the skive and the roller.

11. The method of claim 8 further comprising a logic and control system to control the temperature of the fuser based on the receiver and self-actuated skive movements.

12. The method of claim 8 wherein said receiver has at least one property, and further comprising said logic and control system adjusting said predetermined amount of spring according to said at least one property.

13. The method of claim 8 further comprising said logic and control system delaying the feeding of a first receiving sheet until said predetermined amount of time has passed since the self-actuated skive moved into the second position.

14. The method of claim 8 wherein there is a heat sink in contact with said self-actuated skive.

15. The method of claim 8 wherein self-actuated skive is moved into the second position intermittently.

16. An self-actuating skive for guiding a receiver along a travel path past a contact roller, comprising:
one or more actuation arms located downstream the contact roller such that the actuation arm that is in a first position when the receiver is not in contact with the arm and in a second position when the arm is in contact with the receiver; and
an actuator tip that is proximate the roller when the arm and in a second position when the arm is in contact with the receiver.

17. The apparatus of claim 16 further comprising a controller in communication with the self-actuating skive and the roller to control the pressure on the receiver as it passes the rollers based on information received from the self-actuating skive.

18. The apparatus of claim 16 further comprising a smooth finish on the self-actuating skive.

19. The apparatus of claim 16 further comprising a tension controller to control the tension on the self-actuating skive to controllably change the force between the skive and the roller.

20. The apparatus of claim 16 further comprising a spring actuated self-actuating skive.
